(19) United States
(12) Patent Application Publication
(10) Pub. No.: US 2005/0216512 A1
(43) Pub. Date: Sep. 29, 2005

(54) Method of accessing a work of art, a product, or other tangible or intangible objects without knowing the title or name thereof using fractional sampling of the work of art or object

(76) Inventor: Rahav Dor, Chesterfield, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/077,103

(22) Filed: Mar. 10, 2005

Related U.S. Application Data
(60) Provisional application No. 60/557,042, filed on Mar. 26, 2004.

(51) Int. Cl. G06F 17/00

(52) U.S. Cl. 707/104.1

(57) ABSTRACT

A method of identifying a work such as a musical composition, a text, a video, or a product without the person interested in the object knowing the title of the object. A fractional sampling device is used by the person to acquire a sample of the work and store the sample in the device. The device is subsequently connected to a search apparatus via a physical wire connection, wireless interface, or the Internet. The sampling stored in the device is then provided to the search apparatus. The search apparatus accesses one or more databases in which is stored substantially the entire contents of the work including identifying indicia about the work. Subsequently the search apparatus matches the sample with information about the work stored in the database and provides information identifying the work, related information, or the work itself to the person. This invention also allows a person to perceive a work at the person preferred location and time.

### CROSS REFERENCE TO RELATED APPLICATIONS

Provisional patent application 60/557,042 filed Mar. 26, 2004.

### STATEMENT REGARDING FEDERALLY SPONSORED RESEARCH OR DEVELOPMENT

Not applicable

### BACKGROUND OF THE INVENTION

This invention relates to the access by an individual to various works of art available in a variety of media, to products, to information about these objects, and to other tangible or intangible objects (the works of art, products, related information, and other tangible and intangible objects being collectively referred to as a “work”); locating the work; and to perceiving (viewing, reading, listening to) a desired work in a user preferred setting; or buying the work. In particular, the method and apparatus are directed to accessing works in the particular media or location without the individual having to know the title of the work. Works of art include songs and other musical compositions, literature of all types including books, magazines and journals as well as excerpts from them. Products include the product itself, product information such as the product name, its manufacturer, advertising, promotional, or other material about the product (in any media), manufacturer part number or other industry codes including bar codes and the like. And objects include any object whether tangible or intangible.

It often occurs that someone hears a piece of music that they like and that they would like to listen to again. If the title of the work is available, they can usually access the entire work without a great deal of trouble. However, it is common that the music is heard while the listener is switching channels on a radio, so they do not hear it from the beginning of the piece; or the title is not mentioned. In numerous settings, for example restaurants, nightclubs, stores which play music for the benefit of their shoppers, the title of a piece is hardly ever available. Further, even if the title is announced, it may be inconvenient or risky (for example, when driving a car) to write the title down. The end result is that the title of the work is not known to the listener and they cannot to gain access to hear it again. This leaves the listener with having to go through the wearying process of trying to find the work through music or bookstores, reference libraries, etc. And, even though they may ultimately find out the title of the work this way, it can be a lengthy process; more often than not, the process becomes so tedious that the listener gives up on their search and forfeits their desire. It is also worth noting that even when the title is known, today people need to retain it, have it available at the appropriate time, and actively provide it to be able to find the desired song. FIG. 2 represents the current process as described above.

In another context, it often occurs that someone reads an intriguing article in a setting that does not allow them to complete the reading. Examples of this are while waiting in a doctor's office, noting an interesting heading on the cover of a magazine while passing a newsstand, or browsing a book in a library. To obtain a copy of the article or book for reading or to acquire it can again be a tedious process. In this regard, it is worth noting that there exists today a tacit but mandatory requirement, that to find the magazine and desired article (or similarly other textual content), the reader must remember a few of pieces of identifying information such as the title of the article, the magazine's name or publisher, time of publication, and so on. Even if the person remembers the title or writes it down, in most instances they may not take the time to go to their local bookstore to buy the book or magazine (especially just for the particular desired article). It also often happens that when the person does intend to acquire the magazine, events intrude which prevent them from so. These events include simply forgetting, no time to go get it, or losing the pertinent information about title or publication. The end result is that the benefits, be they simply enjoying the article, or using the information reported in it, are lost.

A similar situation occurs with textbooks and books used for research or other activities that require the reader to obtain a copy of a portion of the text. Once the pertinent text is located, the reader must photocopy it, which can be a lengthy, relatively costly, and tedious process.

In yet another situation, people often see (for example, on TV) or hear (for example, on a radio) advertisements for products about which they would either like to get more information on, or remind themselves to talk with someone about, or purchase. For example, an advertisement for a new medicine might trigger a desire to consult with a physician; or a commercial for a new vacation spot might prompt people to consider going there; or, a new product advertisement might prompt potential buyers to look for the product when they shop in a store or on the Internet. More often than not though, people forget details of the product, its name, its manufacturer, or the advertisement details that might have help them get to the product. People also usually do not to remember a promotion code (if one was expressed in the commercial), and people clearly do comprehend or remember disclaimers concerning the product or promotion. The result is that the benefits the advertiser is trying to convey to the buying public are lost and the product is not considered or bought, or forgotten until it becomes irrelevant.

Yet another aspect of the invention relates to content streaming. With the growth of mobile devices like cellular phones, and increase in our ability to push more content over a narrow broadcast bandwidth, we will start to see services like TV or Video streaming for mobile devices. It will be extremely inconvenient, though, to perceive such content on a small device. If such streaming is interesting to a user, and they are interested in perceiving the content in full; then it is desirable for a person to have a way of “tagging” this content to be provided at a later time, on the user's preferred device and setting, without a requirement on the part of the person remember the content's title, who broadcast it, the time of the broadcast, or other information.

The present invention provides a solution to all of the above, and many other similar dilemmas, by enabling the person to readily, and rapidly identify a work of art and other desirous objects while knowing little or nothing about the work of art or the object; and in particular its title or name.

### BRIEF SUMMARY OF THE INVENTION

Briefly stated, the present invention is directed to a method and apparatus for accessing a portion, or all of, a complete work of art, as well as other types of content, products, information about products and other objects, and any and all other forms of tangible or intangible objects (collectively referred to as “work”). And all of this without knowing the title of the work. With this invention, people desirous of accessing a certain work, do not need to write down, remember, or otherwise know the name of music to which they would like to listen to, the manufacturer or the name of the product they wish to inquire about or buy, or remember who is the publisher or other identifying information about a desired text. The invention uses a partial (fractional) sampling of the work by the capturing method of this invention; that is, a sampling of the text, images, music, advertisement displaying the desired product, video, or other content, or the capture of other relevant data by which the desired work is identifiable. Using data sampled by the capturing method of this invention, the search method of the invention will connect the person with the desired work or provider.

Furthermore, the present invention can maintain a list of works that are of interest to a person, together with all relevant information obtained from the sampling and any additional information obtained by the search method. A requestor can then use the sampled information to allow third party providers to provide the desired work, provide information about the work, or sell a desired work. Alternatively, the person can use the list (which can be copied to a mobile device) to display the work or locate the object in a provider premises. This would be done, for example, in a shop where the product information is shown to a store employee who refers the person to the place in the store where the item is found. Or, where the mobile device interfaces with the store's product directory and the person is electronically directed to the product.

As an apparatus, the invention comprises a device capable of sampling a fraction of a work either from an audio, text, or video source or broadcast, or by acquiring other identifying information (data) about the object. The device stores this information, and later, using a search method of the invention, identifies the work and a media in which it is available. This allows a person to now access the desired work of art or object. Accordingly, the method and apparatus of the invention, “opens a door” to allow a person access to any type of tangible or intangible object such as music, radio programs, concerts, movies, lectures, TV shows, written material such as books and articles, and other forms of content and products. The person can use the apparatus to maintain a list of objects that were sampled and use the list to obtain information about the products, order or buy the products, have a work of art played or broadcast for them. Importantly, the person seeking to identify the object does not need to know any information that would identify the object or the media in which the object is available.

Other objects and features will be in part apparent and in part pointed out hereinafter.

### BRIEF DESCRIPTION OF THE DRAWINGS

FIG. 1 is a simplified representation illustration use of a fractional sampling and search method of the present invention to identify works of art and other objects;

FIG. 2 is a flow chart illustrating a current human process for obtaining information;

FIG. 3 is a flow chart illustrating how information is obtained in accordance with the present invention;

FIG. 4 is a block diagram of a Fractional Sampling Device (FSD10);

FIG. 5A illustrates a work of art data emitter (WOADE20) used with the present invention;

FIG. 5B illustrates use of the WOADE20 to sample information from a non-electronic bulletin board and similar constructs;

FIG. 6A is a block diagram illustrating use of the invention for producing custom magazines;

FIG. 6B illustrates how existing equipment can be used with the aid of the invented process to obtain desired textual information;

FIG. 7 illustrates one example to how music may be obtained using this invention;

FIG. 8 illustrates how information about desired works is copied from the search apparatus objects database to a mobile device, and how specific object's data is displayed to other people, or used to interface to other computer systems, to discuss or locate the desired object;

FIG. 9 illustrates tagging of content in an uncomfortable environment, where that tag is used to order the content to be perceived at desired location and time, record it, or order an electronic or physical copy of it;

FIG. 10 illustrates how sampling of broadcasted events is used to ask a content provider to broadcast additional content; and,

FIG. 11 illustrates how sampling of broadcasted events is used to provide feedback to a voting server.

### DETAILED DESCRIPTION OF INVENTION

The following detailed description illustrates the invention by way of example and not by way of limitation. This description will clearly enable one skilled in the art to make and use the invention, and describes several embodiments, adaptations, variations, alternatives and uses of the invention, including what I presently believe is the best mode of carrying out the invention. As various changes could be made in the constructions described herein without departing from the scope of the invention, it is intended that all matter contained in the description or shown in the accompanying drawings shall be interpreted as illustrative and not in a limiting sense.

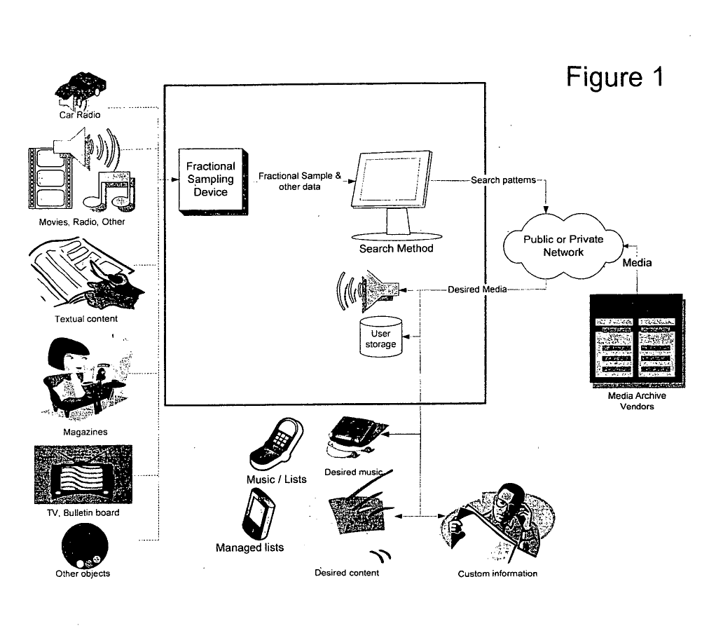

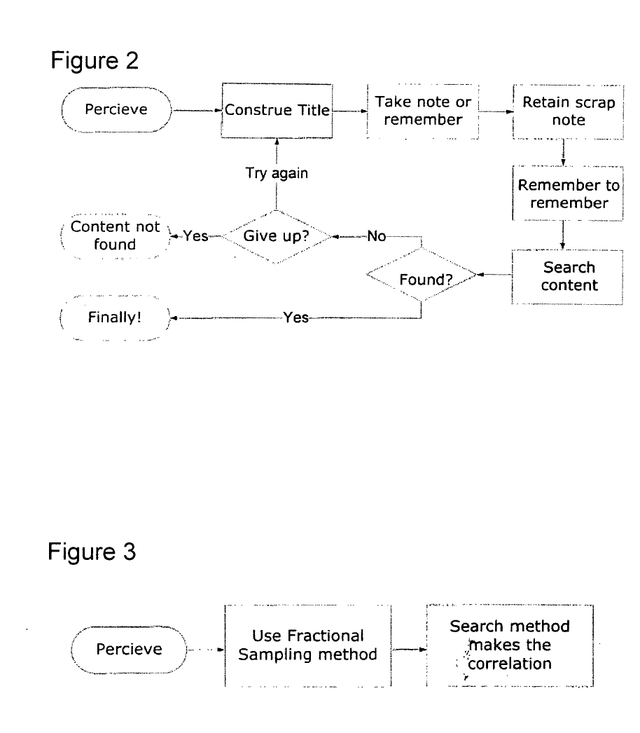

In accordance with the invention, and with reference to FIG. 1, when someone listens to music or other types of broadcasts (e.g., baseball games, public interest discussions, etc.) on the radio, watches a movie, listens to a concert, reads an excerpt from a book or magazine article, views or hears or an advertisement, or is engaged in various other activities involving sounds, text or images—two types of information are present. First is the content of what was heard, read, or seen, and this is the part of what a person perceives. Second is the title of the work and other information about the work or its content. This latter information is not always available to the person. To explain the method of the invention, the following example is for music. However, those skilled in the art will appreciate that the steps described also apply to other textual, visual materials, and physical (tangible) or non-physical (intangible) products.

Often when someone listens to music played on the radio they would like to be able to listen to it again some time later. Or, they may want to acquire a copy of the musical piece for future listening. As previously noted, if the person is not listening at the beginning of the work, he or she may not know the title of the composition, or may not be able to write the title down even if they do hear it, because they busy doing something else (driving a car, cleaning house, etc.). Sometimes, the title is not even mentioned. Even when the title is available it is cumbersome today to retain it for future use.

With the present invention, and as illustrated in FIG. 3, upon hearing a piece of music of interest, the listener uses a fractional sampling device FSD10. This device acquires a portion (fractional sample) of the work. The sampling will stop when the device determines that sufficient data is captured for later identification of the work. For purposes of this invention, fractional sampling is defined as the acquisition of data relevant to the song or event; for example: the broadcasting station ID and the time that the event took place. The amount of data (i.e. sampling magnitude) about the song needed to identify the song is determined by FSD10 based on real-time conditions such as the availability of exact identifying data such as song title, or the call sign (ID) of the broadcasting station along with the time of the broadcast, or less exact data as a recording of the perceivable content.

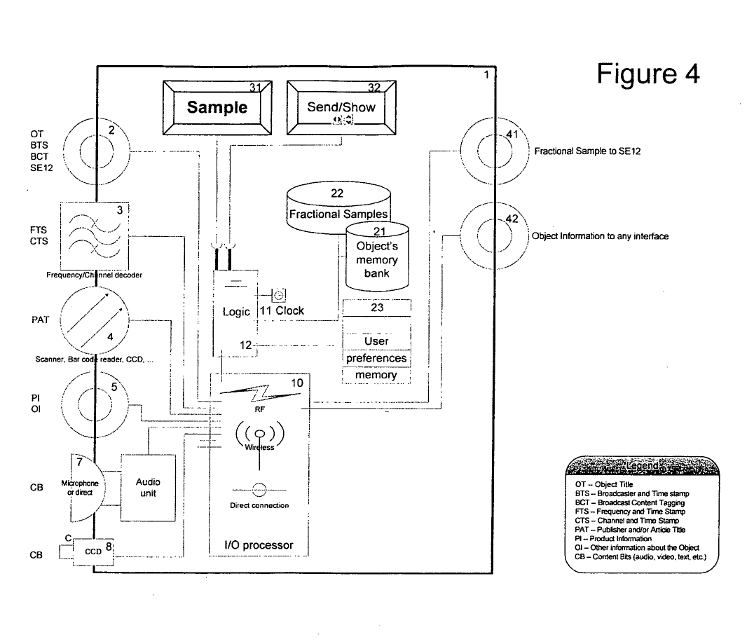

In one embodiment, the fractional sampling device FSD10 is a small hand-held device capable of registering the needed information (see FIG. 4). However, those skilled in the art will appreciate that FSD10 can be incorporated into other devices such as car radios, cellular phones, MP3 and other music players, personal computers (PCs), personal digital assistants (PDAs), remote controls, etc. Regardless of how implemented, the fractional sampling device, when activated, samples the music being perceived by the listener. The sampling length is, for example, 7 seconds, and, as noted, is based on available data and sound quality. It will be understood that the fractional sampling device is capable of sampling more than one piece of music. For example, if a person happens to like many songs they listen to over a period of time (or other objects) between when the FSD10 device is connected to a search apparatus SE12, then the user can obtain numerous samples of songs (and objects of other kinds) he or she wishes to gain access to later on.

At any time, with one or more samplings captured by FSD10, the listener can access a search engine apparatus SE12 to identify and locate the song(s) and other object(s). The search method can be accessed in a number of different ways. For example, the SE12 may be incorporated in a computer system located in the music department of a store, other places of commerce, or in a library. In all of these locations the SE12 can use the facility inventory system or other directory system to locate and refer the shopper to the object of interest. The search method can also be remotely located and accessed by telephone or an Internet connection from the person's home. Importantly, the search method has the capability of accessing a variety of databases one or more of which may contain the desired object (e.g., the song including its title in this example). Those skilled in the art will appreciate that a database can be any repository for information by which the work is identified. The search method uses data captured by FSD10 to identify the song and any other objects being sought. The search method, once it identifies the desired piece of music, provides information back to the person about the composition and the other works. Among the capabilities of the search method are playing the entire composition or a portion of it, as well as providing both the title of the work and its composer. If more than one singer, musical group, or orchestra has recorded the piece, or the song appears in more than one composition (for example as a single, in a CD album, in a movie, or in a live concert) then SE12 can list the names of all who have made a recording, so the listener can select a particular vocalist, band, or orchestra to listen to, or to buy. In a music store, the search method is programmed to direct the listener to the location(s) in the store where recordings of the piece are to be found. In a library, the search method can direct the listener, or a librarian, to the location of the work within the library shelves. Similarly, if the desired object is a physical product, then a SE12 located in a store will direct the shopper to the location where the product can be found.

For text searches, FSD10 can include a picture taking, or scanning capability, or it can download text from an external device (such as a website, PC, Cashier, etc.), or the article's identification (ID) can be typed in using the device keypad. The fractional sample can be of many structures depending on the type of desired text. To locate an article in a magazine the article name, article ID, or the magazine information and page number may be sampled. To locate a textbook or excerpt from a book, the book's title or ISBN, along with page or chapter number, may be sampled. Sampling involves scanning a text or taking a picture of the text (which can subsequently be converted to searchable text by the search method of the invention when required). Once identifying information or an excerpt has been acquired, FSD10 will retain the information in its memory. At any desired time, FSD10 interfaces with search apparatus SE12 and the text or image file is downloaded from FSD10 to the SE12. The search method now converts the raw data into one or more search patterns and provides these to appropriate electronic archives or text databases so to identify the source of the portion of the work it was provided.

As with the music example, the search apparatus may be incorporated in a computer in a bookstore or library, as well as being remotely accessible. Once the work is identified, the title of the work and its author are provided to the user along with other information as it is available from the database. If the work has been published more than once, the name of each publication is also provided. If the work is incorporated with other works in a publication (an anthology of poems, for example), the titles of those works are provided as well. Again, the location within the bookstore where the publications are found is provided. In the library, the location where the works are shelved is provided. If an article was printed in a magazine, then the user is directed to publisher databases and offered access to the article based on the publisher's business terms. In a similar manner texts are offered based the fractional sample defining the book and place in the book of a desired text.

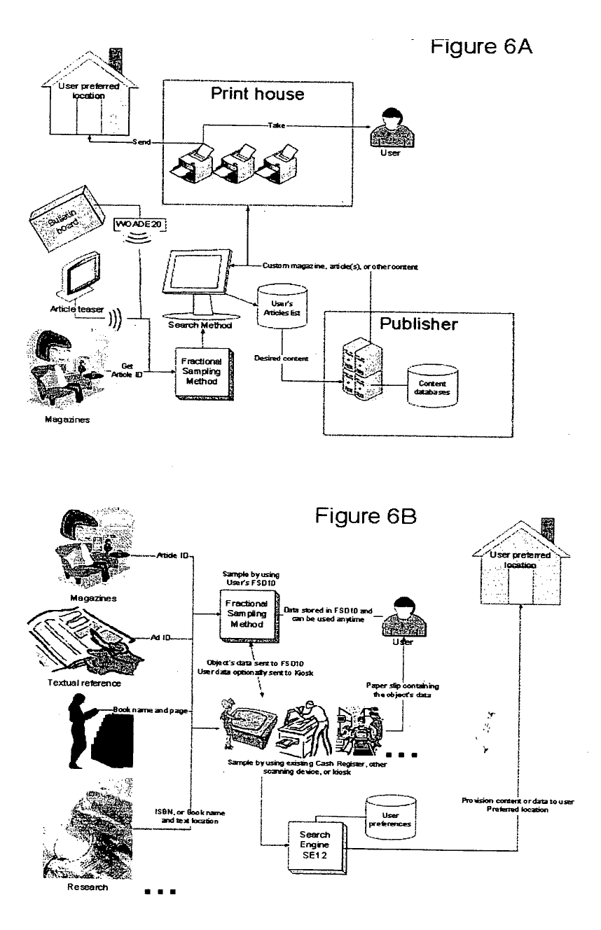

With the availability of the process of the invention, magazine publishers can become more environmentally friendly by changing the paradigm defining where you can find publications, when do you print and sell them, and what is the content of printed magazines; subsequently using less paper and other print materials. Magazines can become electronic teasers broadcasted by publishers to electronic displays or bulleting boards at participating POS (Point Of Sale) locations such as supermarkets, newsstands, and the like; where potential readers can see the teasers and sample the article using an FSD10 method, or electronic devices already installed at that location. The article, the magazine as a whole, or “custom” magazine as described herein can then be provided to a reader using the search method, by providing an electronic copy, custom printed copy, eBook, PC printout, etc. See FIGS. 6A and 6B.

In a manner similar to text information, video images can also be acquired by a fractional sampling method. The search method converts a sampled image into a digital search format and accesses appropriate databases to locate the work. Again, the search apparatus can be incorporated in a computer located in the video department of a store or library to provide not only information about the work to the user, when the work is identified, but also provide location information as to where the work is to be found.

If the desired object is a product of which identifying information was sampled (for example from a commercial or printed advertisement), then the search method can use the sampled information to enable the user to buy the product, or acquire information about the product, its manufacturer, or other related information. Referring to FIG. 8, desired product information is maintained in the general list of works maintained by the search apparatus, and any object from the list that can be refereed to by the user at any time. The list includes sampled information some of which was perceivable content and other information which comprises electronically available data such as that embedded in an advertisement (e.g., channel number and the time of the event, manufacturer or product ID, promotion code, etc.) when these are embedded in a broadcast, and data supplemented by the search method by using the initial fractional sample and searching the appropriate databases. Additionally, the list of objects of interest can be copied to a mobile device like cellular phone, or PDA, etc. and used in a store in conjunction with searching apparatus located in the store to locate the product so it can be bought. FSD10 or the mobile device where the list is maintained can interface with the store's inventory system or other directory system to locate the product and direct the shopper to its location. If a search apparatus is not available at a location within the store, then object information can be visually displayed on the FSD10 or mobile device's screen and presented to a client service representative and others. Similarly, by using the databases of the search apparatus, the user's list of objects can be made available by the user over the internet, and accessed while she or he are in a third party premises. Works from the list can also be directly purchased, or get information on, over the Internet.

With respect to all the above examples, since many books, music, and video publishers, and other merchants, now have Internet websites through which their products can be purchased; the search method can provide appropriate website addresses as well. This latter feature is particularly useful when the person is making an inquiry over the Internet from their home computer. Now, the search method can directly access, or provide the website address of all the Internet sites where the person can go to access or purchase a work of art or other object.

It is important to note that, in all of the above examples, a user needs to know little or nothing about the work of art or an object's identifying information, and that the apparatus and method of the present invention can electronically access available data related to the desired work of art or object. It is further important to note that the information sought is “native” to the work of art or object; that is, the data does not require a human interpretation as to what was perceived about the work or object's identifying information.

One embodiment of a “native matching algorithm” of the present invention facilitates electronic matching of a fractional sampling to its content in a broader context than previously discussed. It is referred to as native electronic matching because the algorithm is carried without intermediate translation to a humanly perceived title. Typically, people correlate a perceived event to the event identifying data; and then, they subsequently use this data to relate back to the event. Heretofore, when someone interacted with a machine (i.e., a computer), they had to provide the machine with necessary event identifying data. In accordance with my invention, however, fractional sampling method FSD10 and search method SE12 capable machines, in one form of their embodiment, directly match event identifying data with the event without any intermediate human correlation as to what was perceived about a work of art or another object, or construction of what is the event identifying data.

Those skilled in the art will appreciate that native electronic matching will, in the future, provide applications for similar machine sensible reasoning not limited to matching between a humanly perceived object and the actual object at a later time. Previously, most human/machine interactions involve human sensible reasoning because a person is the intermediary who provides the machine with some type of data for the machine to perform a desired action or respond in a certain way. “Native electronic matching” as described herein is a novel process by which data is sensible to a machine, but not necessarily to a person, is used by the machine to perform some function.

Fractional sampling method FSD10, as noted, is capable of registering or acquiring needed information to later identify an object. See FIG. 4. A basic FSD10 method has the ability to sample an object title, a broadcaster and time stamp, or short pieces of perceivable sound bits. When the sampling is a recording of part of the perceivable content, the recording is only fractional, and there is no specific requirement to make that sampling available for later playback (even though recording is a type of sampling that can be used by a SE12 method.) More advanced FSDs are capable of registering additional sampling data like the broadcasting station's frequency and a time stamp, as well as capturing video and stills imagery, and other kind of samples.

It will be understood by those skilled in the art that the sample size (sampling magnitude) required by an FSD10 must be sufficiently large such that a sufficient amount of raw data is acquired to allow the work to be identified using the method of the invention. For some searches, this may require more data than for other searches. For example, if an identity (title) cannot be established from a sample, more information may be required; or, more than one fractional sample may be needed to be acquired by FSD10. However, in use, once a user activates an FSD10, they do not need to stop it, but rather can let it run until it automatically stops. The type, amount, and duration of a search sample that FSD10 acquires for each work of art or object, is automatically determined by the method, and requires no input from the user. Each fractional sampling device can, as previously noted, capture a variety of search samples helpful in identifying the object in any media that it is available. The samples are sufficient to generate a useful search pattern by a search engine SE12. Furthermore, sampling can occur at any time, and at any place, within the perceived content. When, during the perceived content, a user activates their fractional sampling method is unimportant.

It is also unimportant that the user know how a search sample is structured, or how or when a particular type of sample is used. Within an FSD10, the specific search samples used to identify an object are stored as appropriate; and, more than one type of search pattern can be used to identify a single object. The FSD10 does, however, in its internal algorithms, utilize a search sample hierarchy to determine which search sample(s) to use to identify a particular type of work of art or object. This hierarchy may, for example, include as follows:
(1) Object Title (OT);
(2) Broadcaster and Time stamp (BTS);
(3) Broadcast frequency and Time Stamp (FTS);
(4) Broadcast channel and Time Stamp (CTS);
(5) Publisher and/or Article Title (PAT);
(6) Product Information (PI);
(7) Content Bits (audio, video, text, etc.) (CB);
(8) Other information about the Object (OI);
(9) Broadcast Content Tag (BCT).

One or more of above search samples may be incorporated by the FSD10, or another device having FSD10 functionality, to identify a work of art or object. Some search samples would be available when the FSD10 is connected (physically or wirelessly) to a radio, television, etc. (collectively referred to here as “transmitters”), other search samples will be collected from the perceivable content.

Referring to FIG. 4, FSD10 can be encased in a small hard shell box 1 with an optional display, or it can be embedded in other devices (camera, mobile phone, car or other radio, paper copier, remote control, etc.). It can be in a form of a key-chain or similar small footprint device.

An FSD10 device will have one or more receptors. All receptors are connected through an independent I/O processor module. That separation between the receptors and the I/O processor module allows the different fractional samples to be obtained in any desired form of connection and communication; for example by using a direct connection to another device (i.e. an FSD10 device connected to a radio via a cable, or direct port on the radio), using a wireless communication of any desired kind, and so on.

The device includes a number of input or reception ports. Port 2, for example, provides an interface to obtain OT, BTS, BCT samples. This input will also be used by FSD10 to accept input from the search apparatus SE12 databases (for example to retain in the FSD10 Object's memory bank 21) works that were sampled in the past and identified by SE12, allowing FSD10 to display the object on its display or transmitting the work's data to another computer system. Port 3 provides a frequency/channel decoder with the functionality of detecting the specific spectrum of broadcast, thus resolving FTS and CTS samples. Port 4 comprises a scanner, bar code reader, CCD, or any other similar component allowing FSD10 to scan these kinds of inputs. This is useful in resolving PAT, Article titles, book names, chapters, page numbers, excerpts, product bar code, and many other similar types of information. Port 5 is similar input to port 2 in that it is used for capturing of samples of types PI and OI. Input 7 comprises a microphone or direct audio receptor to record perceivable sound bits (CB samples). Finally, port 8 is a CCD or other pictorial (stills or video) capturing device to enable the reception of visual CB sample. Those skilled in the art will understand that in a similar manner any desired receptor can be added while still enjoying the same useful process invented here, and that any form of communication will support the useful process.

A control module 10 comprises an I/O processor module. The separation between the receptors and the I/O processor module allows different fractional samples to be obtained in any desired form like physical connection, wireless communication of various forms, and so on. What is achieved is that one can use any preferred method (I/O) of communication and protocol while still enjoying the utility of the invented process.

A clock 11 provides a real time indication of when a certain sample was acquired.

Module 12 is a programmable logic unit sensing a user's click on a sample button 31. The module determines which fractional samples are available to be sampled (with reference to the hierarchy described above), and how can they be sampled (i.e., what connection or communication type does the I/O processor currently sense), and saving the fractional sample in a fractional samples database 22. The logic unit is also responsible for displaying works from the Object's memory bank 21 on an optional FSD10 display (not shown) and allowing the user to select, using key set 32, which desired object to display or supply to another computer system, via using interface output 42.

All of the FSD 10s memory banks can be combined into a single databank. In FIG. 4, they are shown separately for illustration purposes only. Memory bank 21 is a memory that retains information about works that were sampled before and are already identified by the search method. Memory bank 22 is a memory bank that stores fractional samples not yet transferred to a search engine. Memory bank 23 is a memory area that retains information about the user preferred setting and data. These data elements become useful when an FSD10 method need to communicate with another system and the user does not need to provide any input during the process. This memory area retains data elements like email address, preferred location and method to receive custom magazines, home address, POB, IP address, or any other identifying mechanism designating the user's preferred devices, resources, or methods.

Following is an example to the use of this data:
(Step 0) In this memory 23 area the user has previously defined that he likes his home recording device to be the primary way for him to retain TV broadcasts. The electronic address of this device is available.
(Step 1) At any later time as the user views a TV broadcast in an uncomfortable environment, they tags the event using the FSD10 method.
(Step 2) FSD10 sends the user preference to the content provider (or SE12 can do this if immediate interface to the content provider is not possible at the time of the sampling).
(Step 3) The content provider in turn attends to the user request by streaming a copy of the broadcast to the user specified location.

It will be noted that all of this did not require the user to do anything but press Sample button or key switch 31.

FED 10 includes the following controls. Button or key 31, as previously mentioned is a Sample/Tag button. Switch 32 is an optional key array. To simplify the fractional sampling device, and to fit it into very small devices like a key-chain, it is recommended to have just the switch 31 on some designs of FSD10s, and to pull data from an external device, e.g., SE12, without the need to press a send key on FSD10. However, this optional key array, when included in the FSD10 device, can include some or all of the following: navigation keys, one or more action buttons (i.e. [Send], [Show], [Enter]), and an input array to type in numbers and letters.

FSD 10 also has a number of output ports. In a similar manner as described for inputs, all the output ports use the same separation between the ports themselves and the actual communication type. So, interfacing to SE12 or any other system, is achieved in any communication mechanism that is available in the other system and is implemented in the specific FSD10. Output port 41 is used to send information from FSD10 to SE12 by either a “push” from the FSD10 or a “poll” from SE12. Output port 42 is the same as port 41, and allows FSD10 to output information about works stored in its memory banks and to interface with other systems.

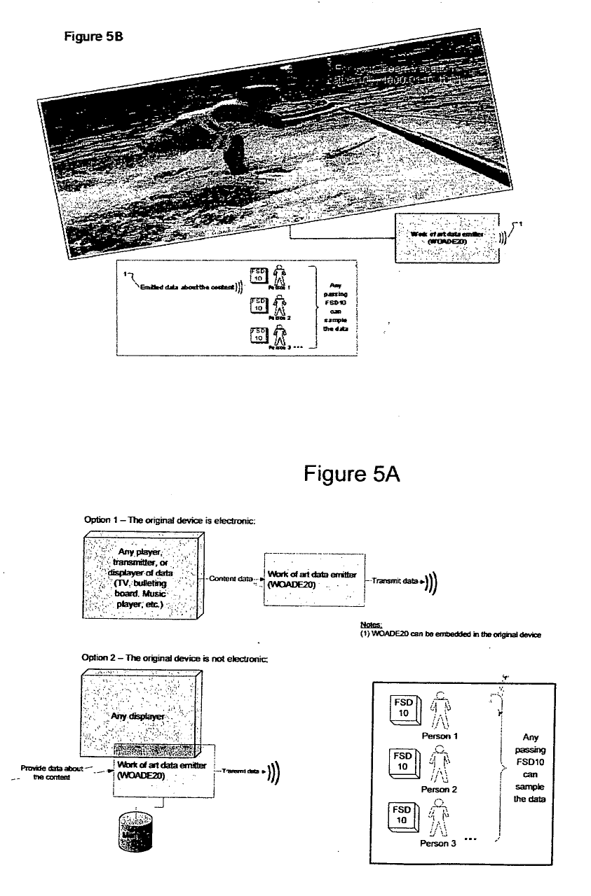

A work of art data emitter WOADE20 is an apparatus connected to, or embedded in, a transmitter (e.g. radio, television, etc.) and any displayer (e.g. a street advertisement board, printed ad, etc.) of data. This is as shown in FIG. 5A. The emitter comprises an emitting interface between the transmitter or displayer and FSD10 devices. For example, in a public place such as a clothing store that plays music for its shoppers, emitter WOADE20 can be connected to the store's music player. A movie theater can use an emitter WOADE20 to provide information about a background song, a movie, or certain scenes in the movie. Emitter WOADE20 acquires the appropriate information from the transmitter or displayer and emits (broadcasts) it through the air, such that FSD10s can capture the emitted data. Alternatively, emitter WOADE20 is functionally integrated into music players and other devices having a playing or displaying capability. Furthermore, as shown in FIGS. 5A and 5B, WOADE20 includes memory in which data identifying and related to the displayed content can be stored. This gives advertisers using non-electronic displays (for example a printed street advertisement, printed ad, bulletin board, etc.) the capacity to enter electronic information about the displayed advertisement to the WOADE20 unit by any desired means like entering it directly on the WOADE20 unit, send the data to the WOADE20 using the Internet, or other communication, and so on. The WOADE20 in turn emits the information using its regular function.

As noted above, some types of fractional sampling benefit from direct connection to a device broadcasting the desired object. For example, music can be sampled by recording audible sounds, but can also be better sampled by obtaining the music's title directly from the broadcast obtained when FSD10 device is connected to a radio. A WOADE20 is an apparatus that facilitates such direct connection for FSD10 devices when the broadcasting device does not have a more direct port available.

Another feature of this method is for advertising purposes. A merchant who is interested in advertising his brand, and has a device capable of emitting relevant data for the use of FSD10s, can add a small piece of data to the emitted information identifying the brand. In conjunction with this data, the SE12 method can display the brand, or a selected advertisement as it displays the search results.

Some search samples from the above list, for example content bits CB, are obtained using recorded sounds, printed (or otherwise displayed) text, or images. Other search samples such as OT and BTS may require a physical or wireless connection to a transmitter or a WOADE20 emitter to obtain the corresponding sampling provided along with, or embedded with, the content.

Further with respect to the search hierarchy, OT (Object Title) sample is a unique identifier (an electronic ID) identifying music, other work being broadcast, or a physical object. Each work of art, or object, may, or can be, assigned a unique identifier by some body setting appropriate standard, whether that body be a government, industry, or private body. The selected identifier is then embedded within the content and broadcast together with the content. This embedded data is then available for FSD10 devices to be captured.

Further with respect to the search hierarchy, in articulating BTS (Broadcaster and Time Stamp) sample, the broadcaster part is information identifying the outlet through which the work of art or object was transmitted, and the time stamp signifies when the event took place.

Similarly, in articulating FTS (Frequency and Time Stamp) sample, the frequency part is the point in the frequency spectrum identifying the outlet (station) through which the work of art or object was transmitted, and the time stamp signifies when the event took place.

In articulating CTS (Channel and Time Stamp) sample, the channel identifies by channel number (station) through which the work of art or object was transmitted, and the time stamp is the time that the event took place.

In articulating PAT (Publisher and/or Article Title) sample, the publisher and/or article title are either the names identifying these entities, or an ID identifying the publisher and the article; or, alternatively, a unique identifier of the article. Again, each publication is assigned a unique identifier by some body setting appropriate standards, whether that body is a government, industry, or private body. The identifier is then printed along with the text, or electronically emitted with the content (e.g., if the text is electronically presented as a “teaser” in a public display).

With respect to articulating PI (Product Information) sample, the product information can be part of a transmission. Any relevant information about the product including its name, product ID (or bar code) or manufacturer part number, advertising or publicity campaign information, and any other relevant information that the manufacturer provides can be embedded in a transmission. This product information will then be electronically available from a broadcast, or emanate from an emitter WOADE20 connected to the device transmitting the content, such that FSD10 devices can sample it as part of a search sample.

With respect to articulating CB (Content Bits) sample, a content bit is any fragment of data humanly perceivable including audio, video, or text data. These, in their electronic native form, are matched to similar bits that define the object when the object, and information about the object, is stored in an electronic format.

As for articulating OI (Other Information about the Object), this parameter relates to other identifying (or non-identifying but relevant) data about the object. Broadcasters, services providers, publishers, or merchants, can choose to identify a product in a number of ways, and embed this information with other unperceived content (price, web address, etc.) of the object.

Concerning BCT (Broadcast Content Tag), this feature involves tagging a broadcast in the memory of a FSD10 device; or alternatively in the provider's or a third party's database, such that the “tagged” content can be referred to immediately, or in the future. In this regard, either FSD10 device tags the perceived content, or the provider stores information about users who tagged the broadcast. This information is later used to refer to the event for any desired purpose such as watching the broadcast from a preferred location, buying merchandise, getting more information about an event, etc.

As a whole this type of data is referred to as object's embedded information or search sample, and the activity of capturing it as fractional sampling.

It will be appreciated that object embedded information can be used for copyright protection purposes and advertisement. Following is one example for the use in a novel type of advertisement: As FSD10 samples the (for example) a song in a clothing store, it will also sample data that identifies the brand in which premises the song was sampled. The search method can then continue to maintain the correlation between the data designating the song and the brand identity. Further, and in accordance with the present invention, many new types of advertising can now be made available; for example, an icon of the brand or other pictorial element can be displayed along with the song title. A short audio or visual or promotion clip can be played in the beginning of the song (that clip can be the same or ever changing clips.). Users can choose to eliminate the clip and pay regular price for buying the song, or designate to retain the clip and pay a reduced price for the song, and so on. What is of essence, enabled by this invention, is the effortless correlation between desired content and brand, creating the new opportunities for these kinds of advertising.

Some search samples can be extended to support the sampling of objects within other objects. For example, a movie which a viewer is watching includes a song played where the song is the object that the viewer is interested in. The song can be denominated as object level 0 (OL0) and the movie as object level 1 (OL1); where OL0 is the object of interest, and there are any number of levels above level OL0 which containing the object or information about it. These multiple levels are supported for the search algorithms of search method SE12.

A search sample will contain sufficient information to point to the desired object and there are a few ways to achieve that. For example one way is to sample the information about OL1 by using an Object Title (OT), and then use Content Bits (CB) to sample OL0. Yet another way to sample OL1 is by using Object Title (OT), and use the event start time, and time shift index to denote when OL0 occurred passed the event start time. The specific algorithm of choice is not of importance to achieve the benefits of this invention, what is of importance and novel is the use of carefully selected pieces of information to enable the useful process of obtaining access to a desired object. We note then that to pinpoint a certain event in time we can extend any desired search sample by using two or more search samples in unison. SE12 will use this extended information to search for the desired content.

For events taking place as a viewer watches TV in his home, it is recommended that their remote control be equipped with FSD10 method. Then, the remote control, or TV, whichever is used to store sampled data can process the information such that the user can access the work they desire. The work is then retained in the user preferred device, i.e., music player, computer, home entertainment center, TV, etc. Similarly, car radios can embed FSD10 method and transfer using any available communication protocol the samples to SE12 available on the user's home PC as the user gets to his home. Other mobile devices (like cellular phones or music players) can be connected (either directly, using a WOADE20, or using any available mechanism) to a car radio. These devices, now equipped with the FSD10 method, will retain the fractional samples; where later these devices will use this data to purchase or otherwise connect the user by using music kiosks (here the word kiosk designate an apparatus similar to an ATM [Automatic Teller Machine]), or the Internet. I can easily foresee that a cellular phone (for example) will interface with a car radio, and used later on in many possible locations like Starbucks®, Wal*mart®, and so on to buy music from a kiosk without the users need to know what exactly they are looking for.

All sampling requiring time as part of the sample can use a time indication provided by one of a number of available sources. For example, time can be extrapolated from a broadcast signal, station programming index, or from an internal clock of FSD10. As a result, fractional sampling, along with data supplemented by the FSD10 method, is used by search method SE12 to identify the broadcast outlet and the desired object.

Those skilled in the art will appreciate that in addition to the foregoing, other search samples can be employed, as appropriate and in accordance with the method of the invention, for identifying objects. These other samples can be used separately, or together, with the search types described herein to direct someone to a desired work of art or object.

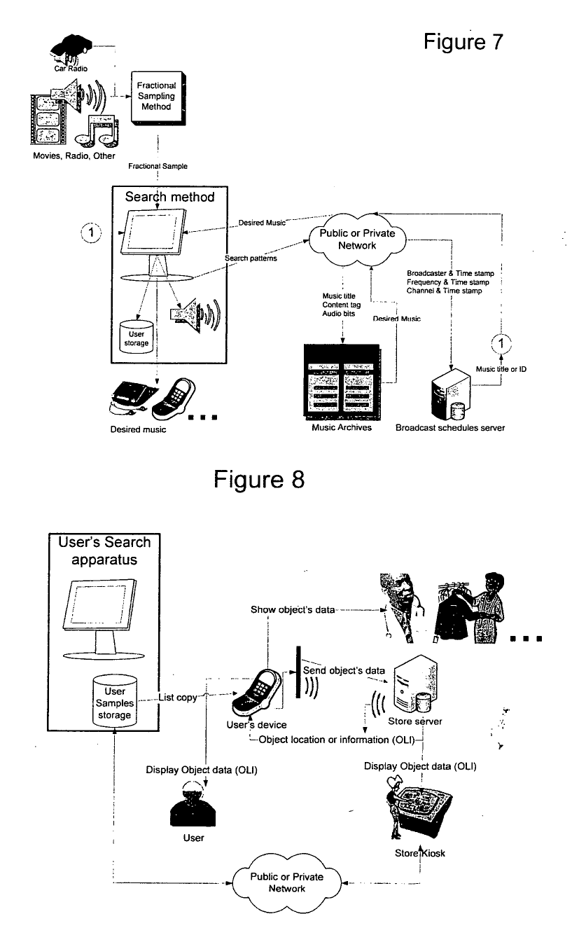

When a user wishes to locate a desired work they physically or wirelessly connect the FSD10 device to a search engine apparatus SE12. The search engine apparatus is implemented either as a discrete device, or as software incorporated into a computer or other device capable of executing the requisite searches. FSD10 transfers the fractional sample as an input to the search apparatus which processes the input data and creates identifying keys. These, in turn, are used by the search method's algorithms to locate the desired work. In one embodiment of the invention, the search method converts the fractional search sample to an identifying key, and then submits the key to a standard search engine (for example to an Internet search site like Yahoo®). For example, referring to FIG. 7, to locate a desired song, a search sample of type FTS is employed by the search method to convert from frequency to station name, then the search method accesses a broadcaster programming schedules database, locate the desired song's textual name (which is a traditional identifying key for any regular Internet search site), and consequentially the search method then interface with a traditional Internet music store to enable the user to access the choices for the pieces of matching music available from that store.

Content or works of art databases utilized by the search apparatus are usually provided by third party content providers and other interested parties. These providers store music, video, text, product, and other content. It will be understood that these database providers may charge a fee for accessing their content and downloading a work of art. The type of access fees—read only, remotely play, download capability, and any other fees will be part of any agreement between the user and database provider.

The search method embodied in, or employed by, search engine apparatus SE12 makes use of agreements with content providers, or uses public databases, to search for a desired object using those databases the user is entitled to access. The search software will match search patterns to available objects identifiable in these databases. When an object is located, the search software enables proper access to the object by passing control to the database provider, or using an electronic “handshake” which takes place between search apparatus SE12 and the content provider's delivery systems to present the data by the search apparatus.

Yet another manifestation of the method of the invention relates to traditional TV broadcasting, mobile TV, video, and other objects of a similar nature. As mobile devices become common place, and as telecommunication protocols push more content into smaller bandwidths, we will see both video and audio streamed to mobile devices; for example, to a cellular phone, hand-held music player, PDA, laptop computer, car TV, etc.

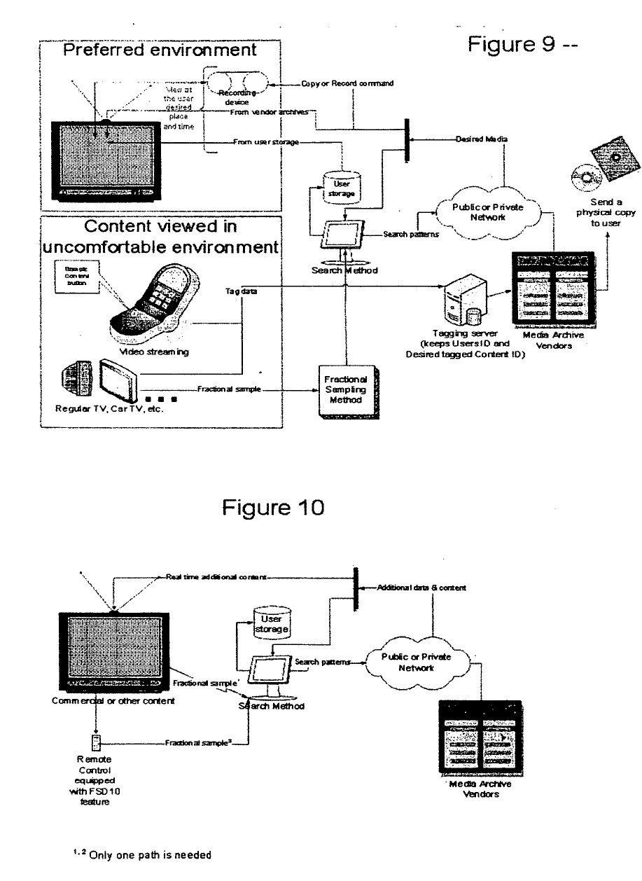

Referring to FIG. 9, viewers may see a particular broadcast at an unsuitable time or place (for example at a friend's house just before dinner, in an hotel, and so on), yet the broadcast intrigues the viewer and she or he would like to watch it at a time and place of their own choosing. My invention allows a viewer to sample or tag the broadcast for future viewing, as well as for obtaining additional information about the broadcast. Following is an example to such a use.

Mobile devices, for example, are characterized by small displays and often an uncomfortable viewing environment. My invention provides the viewer with the ability to readily access the broadcast at a more convenient time and place. See FIG. 9. It is difficult to imagine a cellular subscriber watching a video stream on his or her mobile handset. Furthermore, as video entertainment centers become prevalent in cars, passengers can enjoy a TV broadcast, while hopefully, the driver is not. It is easy to imagine though that such a broadcast will intrigue the cellular subscriber, or a vehicle's driver, enough to trigger a desire to watch that broadcast at a later time and in a more comfortable (and safe) environment.

With my invention, upon seeing or hearing an interesting broadcast, the user employs fractional sampling device FSD10, or a third party device equipped with a fractional sampling method (for example, the transmitter itself) to capture a fractional sample of the broadcast or tag the event. Using the sampled information the desired broadcast (or event) can then be ordered from the original content provider, or other service provider, for transmission to the user's home TV set, PC, or any other preferred equipment, location, and time. The user retaining the tag in their FSD10 can use the search method in their home to order the content, or alternatively when the user tags the content—the content provider, or a third party, can maintain a list of the users who tagged the event. In the second scenario the content provider will display to the user a list of their tagged events, on their preferred viewing device (for example on their TV or PC), and will allow them to choose which broadcast they would like to view.

It is worth noting that as the technology evolves the users will be able to identify themselves (similarly to login on to a computer network) on a transmitter device (for example a home entertainment center in a friend's house, or TV in a hotel) and consequentially access their saved tags from any desired location and device, and view their desired content.

Furthermore, my method affects how we think about recording a broadcast. Again referring to FIG. 9, previously, we could record a broadcast using equipment like a VCR, TIVO, etc., when we either watch the event, or we program the equipment to record the broadcast. My invention now enables someone to watch a broadcast (or a portion of it) at another location, sample it, and ask the content provider to send it to the watcher's preferred recording equipment. Using my invention, one can tag a show that they noticed while on the road, on a mobile handset, at a friend's house or some public place, and ask the content provider to send the program to the watcher's preferred recording location or device.

Information sampled by FSD10 method can also be used to link the viewer, at the time that the original content is perceived, or at a later time, to the provider—to view the broadcast again, or review parts of it, or view additional-content-of-choice relevant to the original broadcast and now made available by the provider. As shown in FIG. 10, the desired content is provided at the user's preferred setting, based on their information maintained in the user preference in the FSD10 device or search apparatus SE12, or a customer profile established with the provider. As previously mentioned, there are numerous ways to access desired content: a request to watch it now, Video-on-Demand, a request that a copy will be sent to the user's home in an electronic form, an operating command to record the event, and even a request to buy and send a hard copy (for example DVD) to our home. Search method SE12 will contact the original content provider, or third party databases which can provide the broadcast to the user, by any medium that the content provider and user prefer to use, according to their agreements and service offering with the specific user.

Additionally, my invention provides a novel method for watching a traditional TV broadcast. When seeing an interesting broadcast, the event is marked (sampled or tagged). Then, using any private or public network (e.g., the Internet, cable, or satellite infrastructure), additional content related to the broadcast can be provided by the original content provider or by a third party. This content is then displayed in an embedded window on a TV, or on any other appropriate device such as a PC. The following is a typical scenario illustrating this method and its benefits. The following example is intended to demonstrate the usefulness of the method without limiting its scope. Please refer again to FIG. 10.

Consider a sport events broadcasted to a TV. There will be numerous viewers who want to only watch the broadcasted game as is and the content sent to their TV screens must not be altered. There may, however, be many others viewers who possibly want more information about the game, possibly during the game itself, with this additional content displayed on the same screen with which they view the event; or alternatively, on another device. By using the fractional sampling method FSD10, the viewer can sample the event such that the user can get either immediate access to the additional content, or that fractional sampling can be used later to access both the event itself and the other content related to the event for later viewing of the same broadcast (a replay), for viewing of related broadcasts, or to get additional information, articles, statistics, buy event related merchandise, and take part in activities or view other items relating to the original broadcast. Furthermore, the broadcasting TV channel, or a third party provider, can set up an internet site with additional discussion areas, statistics, highlights and replays of exciting game moments, replay the exact moment that was sampled, and so on—providing that content either during the game or post-game. The present invention now provides a link between what was originally broadcast, and the added-value-content without the user need to identify the event. The added-value-content can, for example, be accessed via a PC, the Internet, Video on Demand play-back; and if the TV set is also a PC or some other Internet capable device, then the additional content can be provided on the TV display itself. Furthermore, information about the broadcast event (e.g., game statistics) can be sent to the viewer's device of choice, for example the game statistics can be sent to the viewer's PDA.

Similarly to sport events, my invention can be used in many other situations; for example, when watching a movie, viewers might be interested in getting information on, or buying articles or products seen in a particular scene. The fractional sampling method FSD10 will sample the event and the search method SE 12 can connect the viewer to the scene from which they can select the desired object and action.

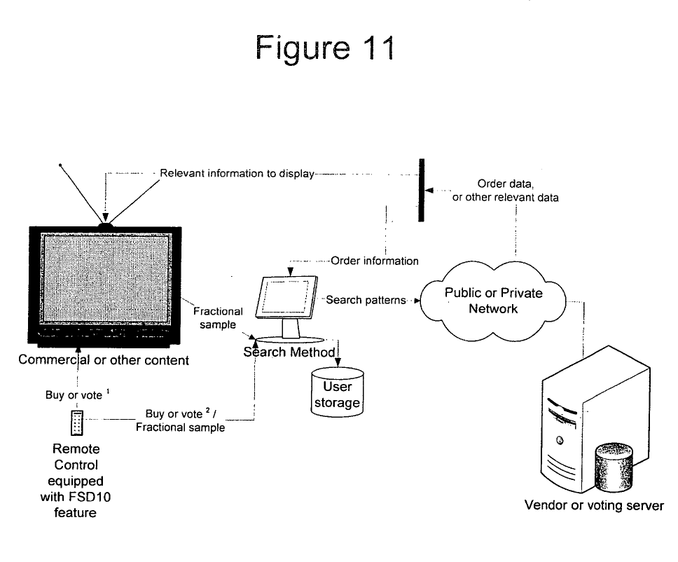

Furthermore, as depicted in FIG. 11, using this process the viewer can provide feedback on the content viewed. The content viewed is sampled using an FSD10 device or another device with sampling or tagging capacity. The tagging information is then communicated to the search apparatus which contact a voting server and relevant voting information or menu is displayed on the original transmitting device or the search apparatus. The user is then able to choose from the voting menu, or approve a purchase, using the same device and again send the data to the server. This feature can be used for game shows, for the buying network, opinion polls during a show, and many other similar situations.

In general, when a user views a TV event they can use a stand alone FSD10 device or another device incorporating fractional sampling method (e.g., a TV's remote control) to acquire a fractional sample of the broadcast. In regard to devices equipped with fractional sampling method, if a TV remote control or a mobile device is equipped with this technology, it would be most convenient to use these devices to do the fractional sampling because the device is already physically close by the viewer.

Yet another manifestation of the useful process of my method relates to books and papers, and magazine and journal articles (see FIG. 6A). Interesting articles are available in printed form in many places. Printed articles are around us when we are in public places—standing in the checkout line at a supermarket, in a doctor's waiting room, at a friend house, and in many other places. It is often the case that we do not have sufficient time to read a complete article in which we become interested, and which we want to complete reading. Similarly when we read books in a library, we might want to have a copy of part of the text. With my invention, the reader no longer needs to photocopy the portion of a book in which he or she is interested. Rather, using fractional sampling method FSD10 the reader can now readily sample the book's title, ISBN, or other identifying information along with desired page or chapter numbers, or a portion of the text. Later, at a convenient time, using the search method SE12, the reader can access available electronic databases, whether those are public or private, to locate the desired text.

It will be understood by those skilled in the art that there are already scanning devices located in many public areas (see FIG. 6B), with the FSD10 method in mind, these devices will be able to enable the useful process invented here; for example, the scanner used by a cashier at he checkout lane of a supermarket or store. Such scanners can be equipped to function as a FSD10 and therefore could be used to print or electronically provide relevant information identifying an article or magazine. The information could be printed on the same cashier's slip already printed by these devices. The information printed could be conventional text, or bar code or similar coded indicia which identify the material being sought. Another option enables the cashier to send a fractional sample to FSD10 device or other mobile device after an article is scanned by the cashier using their regular scanning device. Article identification including the title, author, subject matter and other relevant information will then appear on the cashier's printed invoice and the shopper will use this printed reference to facilitate accessing the desired article at a subsequent preferred time and location (e.g. home), and from a preferred source (e.g., the internet). Alternatively, the store can provide access to the desired article by facilitating the obtaining of the article or magazine from established database and providing it to the customer at a preferred location. Thus, the store can route the material to the customer's email address, their PDA or another mobile device, etc. A search engine apparatus SE12, or a content provider equipped with the search method will use the fractional sampling obtained by FSD10, or the cashier, to provide the desired article from a content provider database or archive or directly from the publisher.

In addition to the above, as articles become available in an electronic media and, for example, are displayed or listed on an electronic bulletin board, then the bulletin board can be configured to emit an article ID which is captured by a fractional sampling method. This is as shown in FIG. 6A.

Regardless of what data is available for fractional sampling the process is straightforward. Using a printed title, text, unique identifier, or other available data, while reading or browsing a magazine in a doctor's office, on an airplane, train, or bus, or any other of a myriad of locations, or as the person views an article “teaser” displayed on a bulletin board; the reader will use the FSD10 method to scan, take a picture of, or otherwise sample the available data about the material. In any case, and in accordance with the invention, search method SE12 will use any of these search samples to locate the desired article.

It will be further understood that a reader can have a batch delivery of articles (see FIG. 6A). In this scenario, a number of articles identified by the reader (maintained in the user's objects list) can be selectively combined by their publisher or a third party clearing house and reproduced as a custom magazine or book which includes the desired articles. This can then be sent to the reader either as a hard copy publication, or in an electronic (for example email) format. This would allow a teacher, for example, to put together a customized textbook for students in a class. It will be appreciated that the publisher will have to have certain rules in place concerning copyrights for the materials as well as royalties which may have to paid to authors of the included materials and to the point of sale where the work was sampled. Further, even there may not be enough material to justify printing a book or magazine, the publisher can still provide the requested articles in a manner by which they can be maintained together for ready reading or reference. Alternatively, the material can be provided in a format which allows the reader to either print the book or magazine themselves, or at a convenient facility such as a Kinko's®. Furthermore, the custom magazine information can be send directly to facilities like Kinko's® such that the requestor can expect a pickup a copy at the store, or be sent to them.

People who read textbooks or other books can use the FSD10 or a device capable of photocopying or scanning in a library to sample a desired book and place in the book; for example using the book ISBN or name, and the page number or chapter. The reader does not need to photocopy all of the desired text. In this regard, even though scanning devices exist in such libraries it will be more convenient to sample using a hand-held FSD10 the beginning and end of any desired excerpts. Later, using SE12 the desired publications or excerpts can be provided to the reader PC or any other requested device.

From the foregoing, it will be seen that fractional sampling with FSD10 method allows the user to access articles and other content directly, or accumulate the material into a batch. Since some readers prefer to read magazines or books, printed and bound with a high quality presentation, information sent to a printing facility will allow the articles to be sensibly organized into a magazine or book form. The user then will have a tailored book or magazine whose pages can look like those in the original paper or magazine, or customized to the reader's interests. For example, the publisher can include ads as they were originally printed, or tailored ads targeted to the reader interests based upon the articles he has requested.

In view of the above, it will be seen that the several objects and advantages of the present invention have been achieved and other advantageous results have been obtained.

1. A method of identifying a work (musical composition, video, text, images, product, or other content, object, or event) without knowing the title or other specific information about the work comprising:
acquiring a sample of the work in an electronic format; and,
providing the sample to a search method capable of accessing a database in which is contained information about the work including identifying indicia, the search method matching the sample with the information in the database about the work and providing back the work or information about the work.

2. The method of claim 1 further including establishing search samples unique to the type of work being identified so to facilitate rapid identification of the work, or collecting information about the work, and handling the data in a device capable of storing and/or communicating it.

3. The method of claim 1 further including acquiring a plurality of samples of one or more works.

4. The method of claim 3 in which a sample of the work is acquired using a fractional sampling device which communicates the data to apparatus performing the search method.

5. The method of claim 3 further including providing the sample or identifying information about the user to a content provider or another service provider.

6. The method of claim 4 in which the device is a stand alone fractional sampling device.

7. The method of claim 4 in which the device is a fractional sampling device incorporated in another device including one of a cell phone, MP3 or other music player, personal computer (PC), personal digital assistant (PDA), radio or car radio, remote control, key-chain, stills or video camera, paper copier, scanner, cashier, digital recorder, TV, electronic bulletin board or other displaying or transmitting devices.

8. The method of claim 7 further in which said another device provides a printout identifying the work, or sends the information to a user device.

9. The method of claim 1 in which the search method generates search patterns from the search sample and includes algorithms to access a database from which the identity of the work or provider may be obtained.

10. The method of claim 9 further including use of the search patterns to obtain additional data about the work.

11. The method of claim 10 further including maintaining a list of the acquired information including a subset of information about the works.

12. The method of claim 11 further including transmitting the list to computer or other device capable of receiving the list, including making the list accessible via the Internet or other information network.

13. The method of claim 12 in which identifying indices of specific item(s) from the list and other data is exchanged with a computer system, or shown to a client service representative (CSR) or other party, where the other system or other party communicates information about the work, including its identity and where it can be found, or automatically sells the item.

14. The method of claim 1 in which information obtained by sampling is used for immediate or a later link to the work or provider.

15. The method of claim 14 in which the work or content related to the work is provided for the user.

16. The method of claim 1 further including storing the sample for identifying the work at a later time.

17. The method of claim 15 in which the content is provided in the same or a different place, and to the same or different device, from where the work was sampled.

18. The method of claim 17 in which the user identifies themselves to the content provider to subsequently receive personal services or content from the provider.

19. The method of claim 14 further including using the sample to establish a link by which a two way communication path between the user and a service provider is established.

20. The method of claim 11 further including collating textual information into a custom publication.

21. The method of claim 2 further including defining standards for printing identifying information about a publisher, article, or excerpt.

22. The method of claim 20 further including electronically providing the custom publication to the user preferred location.

23. The method of claim 1 further including embedding information identifying a work, or data relating to a work, as part of perceivable content related to the work.

24. The method of claim 23 in which the sample includes the source from which the sample was acquired.

25. The method of claim 24 in which the information includes brand information used for promotional purposes.

26. The method of claim 1 in which the sample includes data about the user which can be used for promotional material targeted to the user's interests.

27. The method of claim 1 further including a work of art data emitter apparatus for emitting (transmitting) information useful in identifying the work or data relating to the work.

28. The method of claim 27 in which the emitter is incorporated in other devices for emitting the information obtainable from these devices.

29. The method of claim 27 in which the emitter includes a memory into which information about a work can be stored, the emitter subsequently supplying the information to other devices.

30. The method of claim 29 in which non-electronic displays of work, correlate what they display to the data in the emitter's memory, and therefore the emitter can supply information about what is displayed to other devices.

31. The method of claim 1 further establishing a multi-level search sample to identify a work that is a part of another work.

32. The method of claim 1 further including performing pattern matching of a portion of electronically obtained information with the information as a whole, without human involvement in the matching process.

33. The method of claim 32 in which machine sensible processes exist, where data native to a problem domain is used by the machine to perform an action desired by a machine or a human being, and the method requires no input from a human being.
